(19) United States
(12) Patent Application Publication
(10) Pub. No.: US 2005/0109105 A1
(43) Pub. Date: May 26, 2005

(54) Liquid level indicator using lights

(76) Inventors: Kenneth H. Kowalski, Strongsville, OH (US); David Matthew Crane, Akron, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/968,714

(22) Filed: Oct. 19, 2004

Related U.S. Application Data
(63) Continuation-in-part of application No. 10/661,693, filed on Sep. 12, 2003.

(51) Int. Cl. G08B 21/00; G01F 23/36

(52) U.S. Cl. 73/313; 340/623

(57) ABSTRACT

An indicator assembly for indicating the level of liquid in a tank includes one or more columns of lights that are turned on or off as the level of liquid in the tank rises and falls. The lights may be turned on and off by the passage of a magnetic float that changes the state of magnetically actuatable switches, such as Hall effect transistors, that are associated in a one-to-one relationship with the lights. If two columns of lights are used, they may be of different colors.

### RELATED APPLICATION

This is a Continuation-In-Part application of U.S. patent application Ser. No. 10/661,693 filed on Sep. 12, 2003, the disclosure of which is incorporated herein by reference.

### BACKGROUND OF THE INVENTION

It is known to indicate the level of liquid in a tank or reservoir with mechanical flags. A magnet or magnet assembly is movable up and down with the level of liquid in the tank. As the level of liquid in the tank drops, the magnet moves down alongside the column of flags, which extends for the entire height of the tank. As the magnet passes the flags, it causes the flags to turn, one by one, from a light color to a dark color (or vice versa). Thus, the overall appearance of the column gradually changes, providing an indication of the vertical location of the magnet. The appearance of the column provides an indication of the level of the liquid in the tank. One drawback to this type of level indicator is that it is not inherently visible in darkness. In addition, it includes numerous moving parts (the mechanical flags) that, over time, might stick or lock up.

It is also known to indicate the level of liquid in a tank or reservoir by moving a magnet along a column of individually actuatable, non-latching reed switches. The reed switches are associated in a one-to-one relationship with a column of resistors in series. The resistors are electrically connected with remote electrical circuitry. As the level of liquid in the tank drops, the magnet moves down alongside the column of reed switches. As the magnet passes the reed switches, it causes the reed switches to close, one by one, gradually increasing the overall resistance of the column of resistors. The resistance is sensed by the remote electric circuitry to provide an indication, on a display, of the vertical location of the magnet. The sensed resistance provides an indication to a computer of the level of the liquid in the tank.

### SUMMARY OF THE INVENTION

The present invention relates to a liquid level indicator assembly and to a method of indicating the level of liquid in a tank. The indicator assembly includes one or more lights that are turned on or off as the level of liquid in the tank rises and falls. The lights may be turned on and off by the passage of a magnetic float that changes the state of magnetically actuatable switches, such as Hall effect transistors, that are associated in a one-to-one relationship with the lights. If two columns of lights are used, they may be of different colors, so that the overall appearance of the assembly changes color, for example, from red to green.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of a liquid level indicator assembly associated with a tank containing liquid;

FIG. 2 is an enlarged schematic view of a portion of the indicator assembly of FIG. 1 associated with the tank and a gauge assembly;

FIG. 3 is a schematic front elevational view of a portion of the indicator assembly showing several rows of lights that form part of the indicator assembly;

FIG. 4 is a schematic rear elevational view of a portion of the indicator assembly showing several rows of switches that form part of the indicator assembly;

FIG. 5 is an electrical schematic diagram of a portion of the indicator assembly;

FIG. 6 is a view similar to FIG. 3 of a portion of an indicator assembly constructed in accordance with a second embodiment of the invention;

FIG. 7 is a schematic rear elevational view of a portion of the indicator assembly of FIG. 6;

FIG. 8 is an electrical schematic diagram of a portion of the indicator assembly of FIG. 6;

FIG. 9 is an enlarged schematic view of a portion of an indicator assembly associated with the tank and a gauge assembly;

FIG. 10 is a schematic diagram of the magnetic device associated with the tank and gauge assembly;

FIG. 11 is an enlarged schematic view of a portion of an indicator assembly showing the states of lights as a result of power up;

FIG. 12 is an electrical schematic diagram of an indicator assembly of FIG. 10;

FIG. 13 is an electrical schematic diagram of an alternative indicator assembly;

FIG. 14 is an electrical schematic diagram of a negatively configured power supply having an AC input power source;

FIG. 15 is an electrical schematic diagram of a positively configured power supply having an AC input power source;

FIG. 16 is an electrical schematic diagram of a negatively configured power supply having a DC input power source;

FIG. 17 is an enlarged schematic view of a portion of an indicator assembly having lights remotely located from corresponding switches;

FIG. 18 is a schematic view of a liquid level indicator assembly associated with a tank containing liquid;

FIG. 19 is a schematic view of a liquid level indicator assembly and having two types of lights associated with a tank containing liquid;

FIG. 20 is a schematic view of an indicator having a circular shaped light display;

FIG. 21 is a schematic view of an indicator having an arcuately shaped light display; and

FIG. 22 is a schematic view of an indicator having a linear shaped light display.

### DESCRIPTION OF THE INVENTION

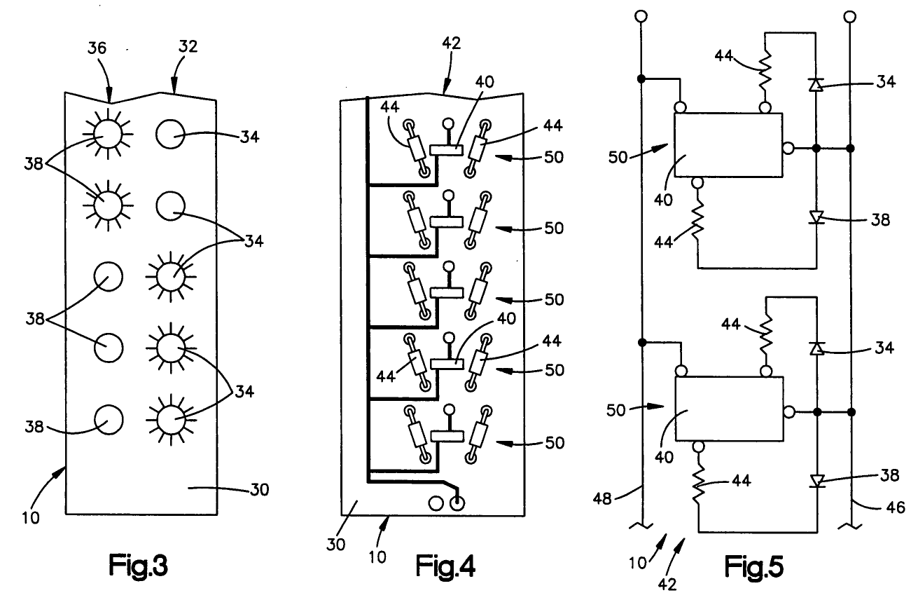

The present invention relates to an indicator assembly for indicating the level of liquid in a tank. The invention is applicable to indicator assemblies of varying constructions. As representative of the invention, FIGS. 1-5 illustrate an indicator assembly 10 that is constructed in accordance with a first embodiment of the invention.

The indicator assembly as illustrated is used for indicating the level of liquid in a tank, such as the tank shown schematically at 12. The tank 12 has a side wall 14. The liquid level in the tank shown in FIG. 1 is indicated by the line 16. The indicator assembly 10 is usable with other types of tanks or reservoirs or liquid containers than that shown.

A gauge assembly 20 is mounted on the tank side wall 12. The gauge assembly 20 may be of one of the types shown in U.S. Pat. Nos. 5,647,656; 5,645,336; and 5,743,137, the disclosures of which are incorporated herein by reference. The gauge assembly 20 as illustrated includes a cylinder 22 containing liquid 24. The level of the liquid 24 in the cylinder 22 varies with the liquid level 16 in the tank 12.

A float 26 is suspended in the liquid 24 in the cylinder 22 and rises and falls with the liquid level in the cylinder 22. The level of the float 26 thus indicates the liquid level 16 in the tank 12. The float 26 carries a magnet or magnet assembly that produces a magnetic field, indicated schematically at 28. Although the float 26 is shown disposed within the gauge assembly 20, the float 26 may be located in other locations, such as with in the tank 12.

The indicator assembly 10 is supported adjacent the gauge assembly 20. The indicator assembly 10 includes a substrate or base 30. In one embodiment, the indicator assembly 10 is formed as a printed circuit assembly with components mounted on a suitable circuit board as the base 30.

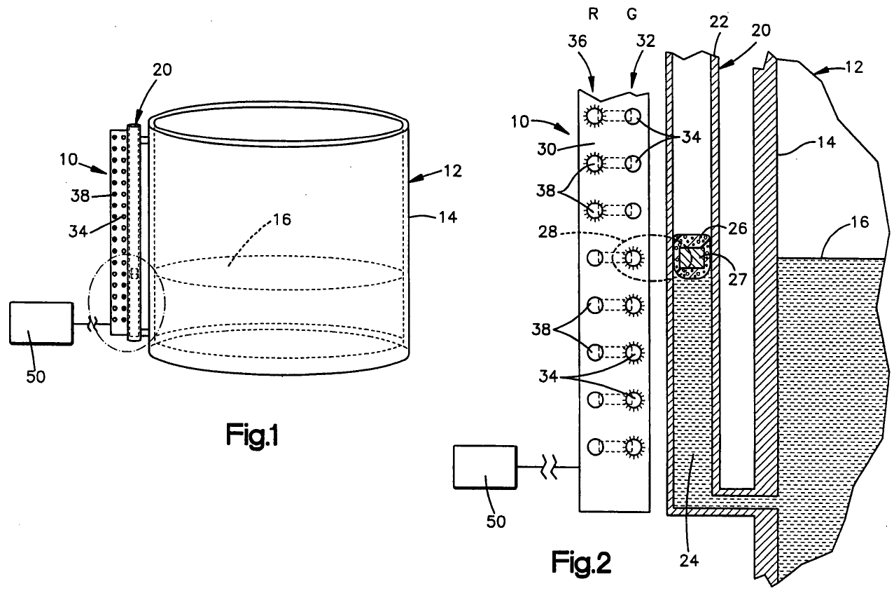

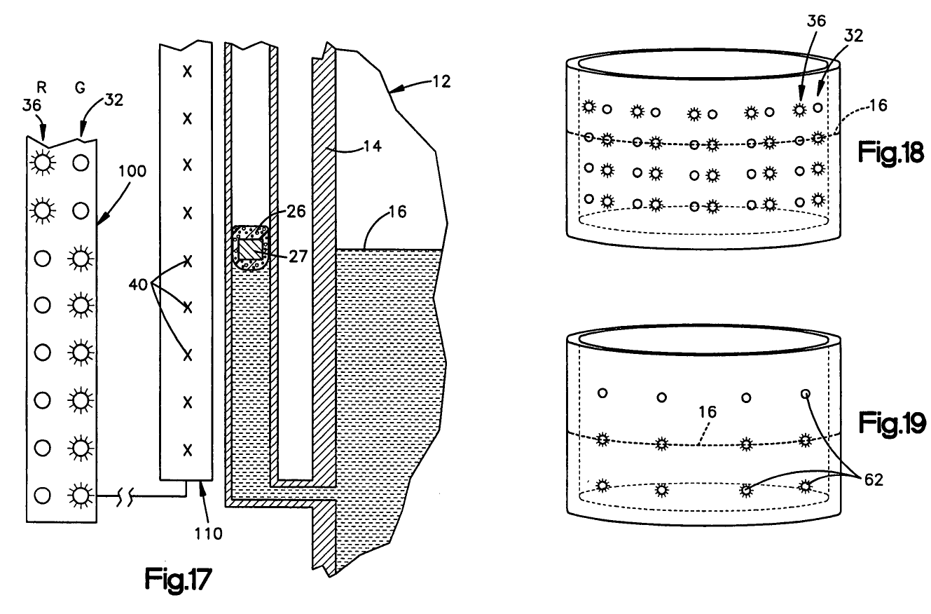

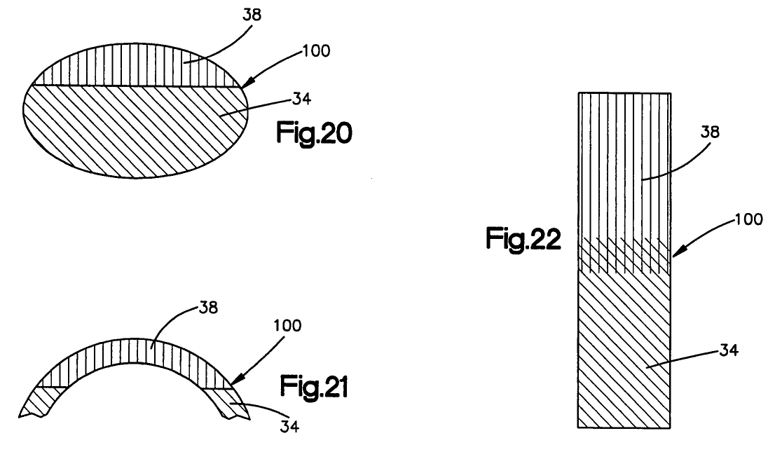

In the embodiment shown in FIG. 2, two columns of lights are mounted on the base 30. The arrangement of lights is not critical and may take various shapes. For example, the lights may be arranged in a circular, arcuate or linear shape as shown in FIGS. 20-22. The lighting display may be more continuous, as in a fever strip, rather than with discrete bulbs. Furthermore, the lights may be arranged in multiple columns as shown in FIGS. 18-19. The two columns of the embodiment illustrated in FIG. 2 include a first column 32 including a plurality of fluid-present lights 34, and a second column 36 including a plurality of fluid-not-present lights 38. The lights 34 and 38 are preferably LED's, but could be another type of light. When the indicator assembly 30 is in use it is mounted so that the columns 32 and 36 extend vertically alongside the gauge assembly 20.

The lights in the two columns 32 and 36 are preferably, but not necessarily, of different colors when energized. In the illustrated embodiment, the fluid-present lights 34 in the first column 32 are green LED's, and the fluid-not-present lights 38 in the second column 36 are red LEDs. The color of the lights is not critical.

Also mounted on the base 30 of the indicator assembly are a plurality of magnetically actuated switches 40 that are electrically connected with the lights 34 and 38 in a circuit 42 as described below. A plurality of resistors 44 are also mounted on the base 30 and are electrically connected with the switches 40 and the lights 34 and 38 in the circuit 42 as described below.

The switches 40 are preferably Hall effect transistors. Hall effect transistors are preferred because they are activated by such a magnetic field, they are less expensive than reed switches, and are more durable thermally, electrically, and physically. The Hall effect transistors could, alternatively, be replaced another type of switch 40, such as a reed switch, which can be switched by the particular level of magnetic force that is generated by the gauge assembly 26. Other types of non-magnetically actuatable switches can be used and are considered within the scope of the present invention. One commercial gauge assembly 20 generates approximately 120 gauss in the plane of the switches 40.

As shown schematically in FIGS. 4 and 5, the circuit 42 on the board 30 includes a plurality or series of “cells” 50 each of which includes two lights 34 and 38, a transistor 40, and two resistors 44. The two lights 34 and 38 are connected with one terminal of the transistor 40. The one terminal is also connected to a positive bus 46 on the base 30.

The green light 34 is connected in series with one resistor 44 to a second terminal of the transistor 40. The red light 38 is connected in series with the other resistor 44 to a third terminal of the transistor 40. A fourth terminal of the transistor 40 is connected to a negative bus 48 on the base 30.

A remote readout, indicated schematically at 50, is electrically connected with the indicator assembly 10. The remote readout 50 can be a series of lights, or a gauge, or a computer system, for example, located in a building or room that is adjacent to or remote from the actual tank 12. If a remote readout 50 is used, the lights 34, 38 do not have to be physically located at the tank 12 or gauge 20.

As the liquid level 16 in the tank 12 rises and falls, the level of the liquid 24 in the cylinder 22 also rises and falls. The float 26 moves with the liquid level in the cylinder 22, that is, in response to rising or falling liquid level 16 in the tank 12. As the float 26 moves, the magnetic field 28 that it produces moves vertically along the length of the indicator assembly 10.

When the indicator assembly 10 is first powered up, all the Hall effect transistors 40 are in steady state closed output. As a result, all the red lights 38 are energized (assuming no magnetic field is present at the location of the transistors 40).

As the float 26 rises or falls, it actuates serially the switches 40. Specifically, as the float 26 rises past each transistor 40, the magnetic field 28 of the moving float causes, in response, a small current to be generated within each transistor that the field passes. This current switches the output of the transistor 40 so that the open output closes and the closed output opens. In response, the red light 38 is de-energized and the green light 34 is energized.

Thus, as the float 26 and its magnetic field 28 move upward along the length of the indicator assembly 10, past the levels indicated by the pairs of associated red and green lights 38 and 34, the red light 38 at each level is turned off and the green light 36 is turned on. As a result, in the indicator assembly 10, one and only one member of each pair of lights 38 and 34 is illuminated.

The transistors 40 are latching devices. Therefore, when the magnetic field 28 moves away from a transistor 40, the transistor maintains its state until another, subsequent, magnetic force causes it to switch back to its previous state. Thus, when a red light 38 is turned on or off, it maintains that state, and when a green light 34 is turned on or off, it also maintains that state.

As a result, the level of liquid 16 in the tank 12 is visible external to the tank 12, in a self-illuminated manner that can be seen in the dark. In addition, the remote readout 50 can indicate remotely the level of liquid 16 in the tank 12. Thus, the level of liquid 16 in the tank 12 can be read both at the tank itself, near (within visible range) of the tank, and at any distance over which an electrical signal can be sent.

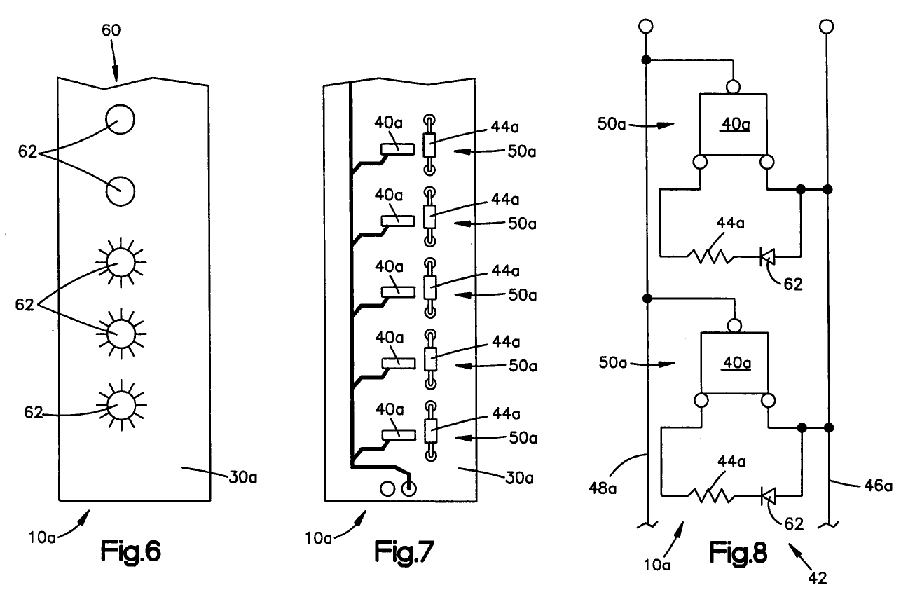

FIGS. 6-8 illustrate an indicator assembly 10a that is constructed in accordance with a second embodiment of the invention. Parts of the indicator assembly 10a that are the same as or similar to parts of the indicator assembly 10 (FIGS. 1-5) are given the same reference numerals with the suffix “a” attached.

The indicator assembly 10a includes only one column 60 of lights 62 mounted on the base 30a. The lights 62 are preferably LED's arranged in rows, with only one LED in each row. All the lights 62 are preferably of the same color, and could be, for example, white when illuminated. When the indicator assembly 10a is in use it is mounted so that the column 60 of lights 62 extends vertically alongside a gauge assembly.

Also mounted on the base 30a of the indicator assembly 10a are a plurality or series of magnetically actuated switches 40a that are electrically interconnected with the lights 62 as described below. As in the first embodiment, the switches 40a are preferably Hall effect transistors. A plurality or series of resistors 44a are also mounted on the base 30 in a one-to-one relationship with the switches 40a and the lights 62.

As shown schematically in FIGS. 7 and 8, the circuit 42a on the board 30a includes a plurality or series of “cells” 50a each of which includes one light 62, a transistor 40a, and one resistor 44a. The light 62 is connected with one terminal of the transistor 40a that is connected to a positive bus 46a on the base 30a. The light 62 is connected in series with the resistor 44a to a second terminal of the transistor 40a. A third terminal of the transistor is connected to a negative bus 48a on the base 30a. A remote readout (not shown) may also be electrically connected with the indicator assembly 10a.

The indicator assembly 10a is associated in operation with a tank 12 and a gauge assembly 20 as in the first embodiment of the invention. When the indicator assembly 10a is first powered up, all the Hall effect transistors 40a are in steady state closed output. As a result, all the lights 62 are energized (assuming no magnetic field is present at the location of the transistors 40a).

As the float 26 rises or falls, it actuates serially the switches 40a. Specifically, as the float 26 falls past each transistor 40a, the magnetic field 28 of the moving float causes, in response, a small current to be generated within each transistor that the field passes. This current switches the outputs of the transistor 40a, and in response, the light 62 associated with the transistor is de-energized (turned off).

Thus, as the float 26 and its magnetic field 28 move downward along the length of the indicator assembly 10a, past the levels indicated by the lights 62, the energized light at each level is replaced with a de-energized light. When the magnetic field 28 moves away from a transistor 40a, the associated light 62 maintains its on or off state until a subsequent magnetic field switches the transistor. As a result, the indicator assembly 10a provides an indication of the level of liquid in the tank 12 which is visible external to the tank, in a self-illuminated manner, that can be seen in the dark. In addition, the level of liquid in the tank 12 can be read remotely, as above, if desired.

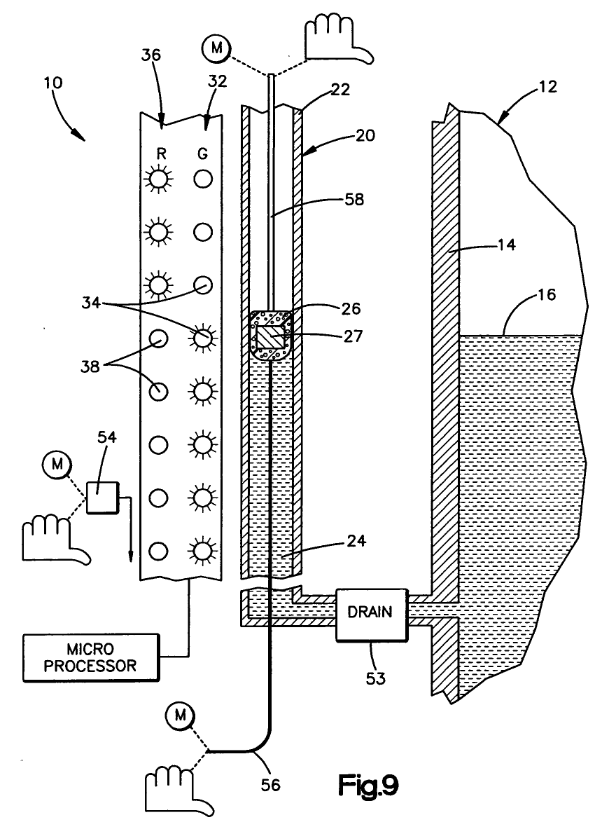

FIGS. 9-12 illustrate an indicator assembly 10 in accordance with another embodiment of the invention. The indicator 10 has two columns 32, 36 of lights. The first column 32 contains fluid-present lights 34 and the second column 36 contains fluid-not-present lights 38. At each discrete vertical position, there is a pair of lights, one fluid-present light 34 and one fluid-not-present light 38. The pairing of lights is not critical but is preferred. The fluid-present lights 34, during normal operation, are intended to indicate when lit that the fluid level 16 is at least at that vertical level. Conversely, the fluid-not-present lights 38, during normal operation, are intended to indicate when lit that the fluid level 16 is not currently at that vertical level.

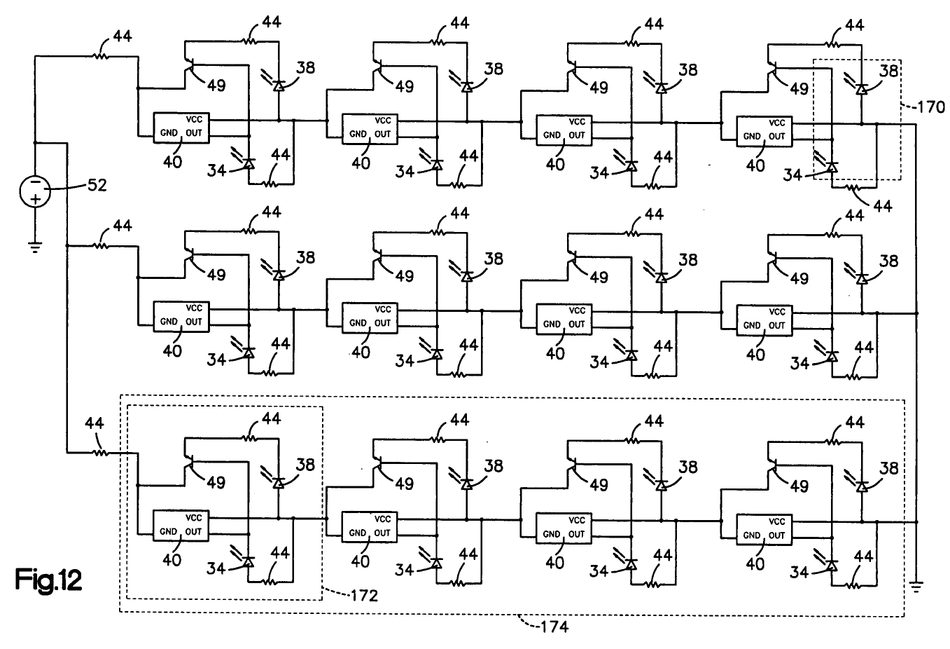

As shown in the electrical schematic of FIG. 12, each pair 170 of lights is associated with a magnetically actuatable switch 40 and a control transistor 49. The magnetically actuatable switch 40 is preferable a latching Hall effect transistor. The gate of the control transistor 49 is electrically connected to the output of the magnetically actuatable switch 40. As a result, when the magnetically actuatable switch 40 is off and in an open state, the control transistor 49 opens to allow current to flow through the fluid-not-present light 38, while the magnetically actuatable switch prevents current from flowing through the fluid-present light 34. Conversely, when the magnetically actuatable switch 40 is on and in a closed state, the control transistor 49 closes to prevent current from flowing through the fluid-not-present light 38, while the magnetically actuatable switch allows current to flow through the fluid-present light 34.

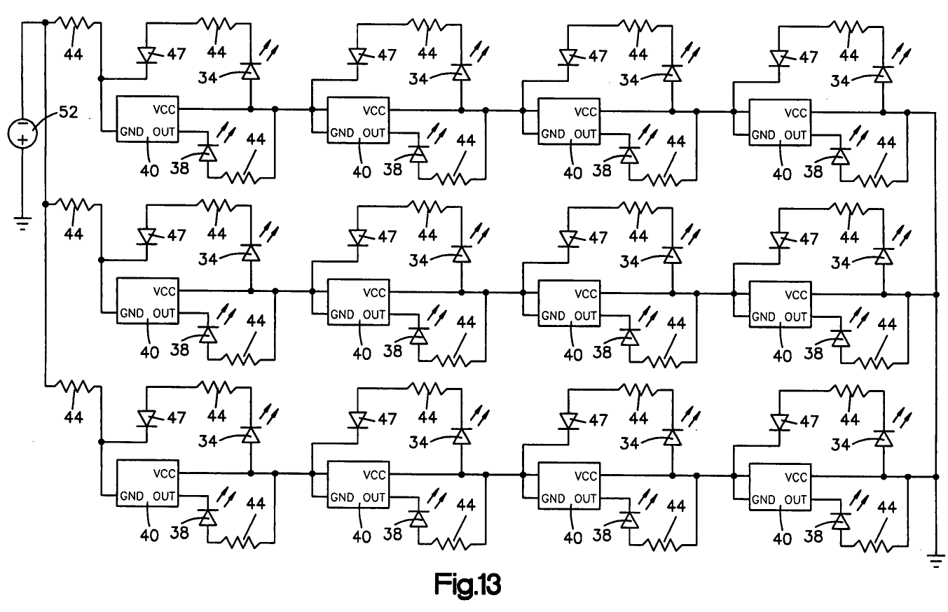

Groups 172 (FIG. 12) of at least lights 34, 38 and a magnetically actuatable switch 40 are connected in series with other groups 172. The collection of series-connected groups form a branch 174. Depending on the size of the indicator 10, it may be necessary to include multiple branches 174. Multiple branches 174 are electrically connected in parallel between a negative input voltage source and ground to complete the basic circuitry for the indicator 10. While this circuitry is preferred, other circuit designs are possible. For example, FIG. 13 shows another embodiment of a circuit for an indicator 10. In that embodiment, a different type of magnetically actuatable switch 40 is used. Furthermore, a diode 47 is electrically connected to the fluid-present lights 34. Like the circuit shown in FIG. 12, the embodiment of FIG. 13 is also driven by a negative DC voltage.

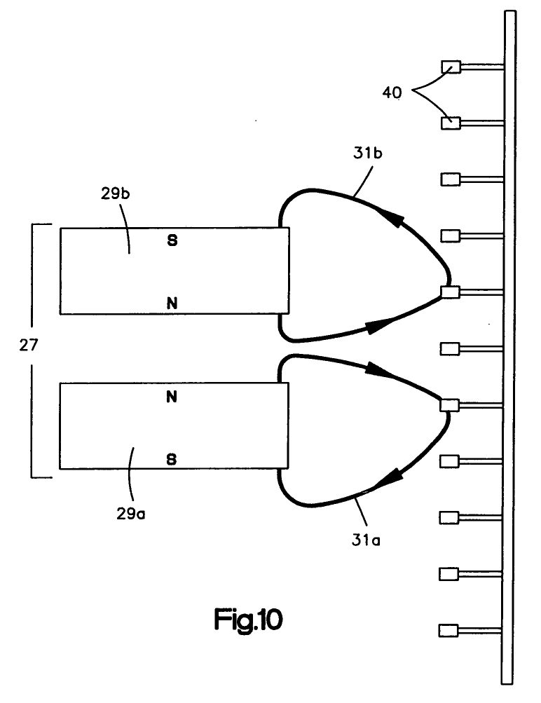

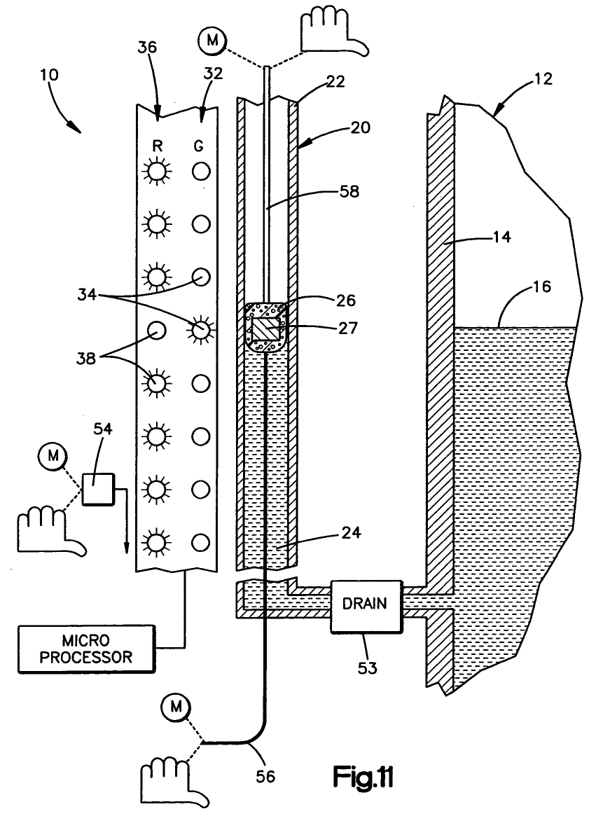

Using the indicator circuit illustrated in FIG. 12, the lights 34, 38 are turned on and off as the float 26 rises and falls. Specifically, the float 26 provides a magnetic field 28. This may be accomplished using a magnetic device 27 disposed within the float 26. The particular latching magnetically actuatable switches 40 are actuated when a magnetic field in a first direction flows through and will only change state when a second magnetic field, opposite to the first direction, flows through. Accordingly, to change the state of the magnetically actuatable switch 40 of FIG. 12, the float 26 must provide two magnetic fields which are opposite in direction. In the particular embodiment shown in FIG. 10, the magnetic device 27 provides two magnetic fields 31a, 31b which are opposite in direction. Specifically, magnetic field 31a flows in a clockwise direction while magnetic field 31b flows in a counterclockwise direction.

To provide the two magnetic filed 31a, 31b, the magnetic device 27 provides two magnets 29a, 29b arranged in polarly opposite directions. Although two discrete magnets are used in this embodiment, the present invention is not limited to using two magnets. The top magnet 29b provides the counterclockwise magnetic field 31b while the bottom magnet 39a provides the clockwise magnetic field 31a. As a result, the magnetically actuatable switch 40 switches off when magnetic field 31b passes through the magnetically actuatable switch, and the magnetically actuatable switch switches on when magnetic field 31a passes through the magnetically actuatable switch.

By the use of latching magnetically actuatable switches 40 and a float 26 which provides two opposing magnetic fields 31a, 31b, the fluid-present lights 34 and the fluid-not-present lights 38 may be turned on and off to properly indicate the fluid level 16 in a tank 12. Specifically, as the float 26 rises, the magnetic field 31b is the first magnetic field to pass through the magnetically actuatable switch 40. This switches the magnetically actuatable switch 40 to an off state, which turns off the fluid-present light 24 off (if not already off) and simultaneously turns on the fluid-not-present light 38 (if not already on). As the float 26 continues to rise, the oppositely-directed magnetic field 31a then passes through the same magnetically actuatable switch 40. This causes the magnetically actuatable switch 40 to switch to an on state, which turns on the fluid-present light 34 and turns off the fluid-not-present light 38. The buoyancy and density of the float 26 are adjusted and calibrated such that the liquid level 16 is located approximately between magnetic field 31a and 31b.

As the float 26 continues to rise, each subsequent magnetically actuatable switch 40 is actuated in a similar manner, i.e., turned off by magnetic field 31b and then turned on by magnetic field 31a. Thus, as the float 26 rises with the liquid level 16, fluid-present lights 34 located below the liquid level 16 are latchedly turned on (if not already on) while the fluid-not-present lights 38 located below the liquid level 16 are latchedly turned off (if not already off).

When the float 26 descends, the reverse sequence of actions occur. Specifically, as the liquid level 16 drops and the float 26 descends accordingly, the magnetic field 31a passes through a magnetically actuatable switch 40. The magnetic field 31a switches the magnetically actuatable switch 40 to an on state, which turns on the fluid-present light 34 (if not already turned on), and simultaneously turns off the fluid-not-present light 38 (if not already turned off). As the float 26 continues to descend, the oppositely-directed magnetic field 31b then passes through the magnetically actuatable switch 40. This causes the magnetically actuatable switch 40 to be switched to an off state, which turns off the fluid-present light 34 and simultaneously turns on the fluid-not-present light 38. Thus, as the float 26 descends with the liquid level 16, the fluid-present lights 34 located below the liquid level 16 are latchedly turned on (if not already on) while the fluid-not-present lights 38 located below the liquid level 16 are latchedly turned off (if not already off).

As discussed above and as shown schematically in FIG. 17, the lights do not necessarily have to be physically adjacent to the tank 12 or the gauge assembly 20, but may be located at a remote location. In that instance, the arrangement of lit lights would be representative of the liquid level 16 in relation to the tank 12. Thus, the turning on and off of lights located below the liquid level 16 would be understood by those of ordinary skill in the art to mean turning on and off the lights that are located below the represented liquid level and not the lights that are “physically” below the liquid level 16. For example, if a tank 12 that was 50% full were at the top of a hill and the remote lights were displayed remotely at the bottom of the hill, although every light would be “physically” below the liquid level 16, the remote lights would indicate that the tank 12 was 50% full by lighting only the top half of the fluid-not-present lights 38 and by lighting only the bottom half of the fluid-present lights 34.

During normal operation, the fluid-present lights 34 located below the liquid level 16 are on and the fluid-not-present lights 38 located below the liquid level are off. Conversely, the fluid-present lights 34 located above the liquid level 16 are off and the fluid-not-present lights 38 located above the liquid level are on. However, if power to the indicator 10 is interrupted (or before the indicator is initially powered up), all the lights turn off. It is desirable that, upon subsequent power up of the indicator 10, the lights be set (or reset) to their correct condition, representative of the liquid level 16 at the time of power up. This can be accomplished in accordance with one embodiment of the invention.

Specifically, upon power up (either initial start up or following a power outage) of the indicator 10, all of the magnetically actuatable switches 40 are in the off state, except for the magnetically actuatable switches 40 that are located adjacent to the float 26. This is a function of the selected magnetically actuatable switch 40. For example, when the magnetically actuatable switch 40 is an A3187EUA-type latching Hall effect transistor, upon power up, the default state of the A3187EUA is the off state. These same properties exist in other types of Hall effect transistors, including but not limited to UGN3175XUA and UGN3177XUA type transistors. In such a circumstance, therefore, the fluid-not-present lights 38, each of which is associated with a magnetically actuatable switch 40 in the off state, are turned on; while all the fluid-present lights 34 associated with a magnetically actuatable switch 40 in the off state, are turned off.

The exception is those particular magnetically actuatable switches 40 that are adjacent to the float 26 and that receive the magnetic fields 31a, 31b. Any magnetically actuatable switch 40 that receives magnetic field 31a at the time of power up, is switched to the on state. When this occurs, the fluid-present lights 34 associated with that particular magnetically actuatable switch 40 are turned on, and the fluid-not-present lights 38 associated with that particular magnetically actuatable switch 40 are turned off.

The remaining magnetically actuatable switches 40, that is, the ones that are not adjacent to the float 26, are in the off state. The remaining fluid-present lights 34 are turned off and the remaining fluid-not-present lights 38 are turned on. Accordingly, after and as a result of power up, all fluid-not-present lights 38 are on except those whose magnetically actuatable switches 40 are adjacent to the float 26. Similarly, all fluid-present lights 34 are off excepts those whose magnetically actuatable switches 40 are adjacent to the float 26. This post-power up state is schematically shown in FIG. 11. The light display on the indicator 10 immediately following power up indicates the liquid level 16 by turning on only the fluid-present lights 34 adjacent to the float 26.

While this post-power up display does indicate the liquid level 16 of the tank 12, many of the lights 34, 38 are not set to their correct states. Fluid-present lights 34 located below the float 26 are turned off, when during normal operation these lights would be turned on. Similarly, fluid-not-present lights 38 located below the float 26 are turned on, when during normal operation these lights would be turned off. It may be desirable to set all the lights 34, 38 to their correct states.

FIG. 9 illustrates several different apparatuses to set lights 34 and 38 to their correct state after power up. First, a drain 53 may be provided at the bottom of the gauge assembly 20. The drain 53 allows the fluid in the gauge 20 to be drained, while the fluid in the tank 12 is not drained. By doing so, the float 26 and the magnetic device 27 descend past the lights 34, 38 that are located below the liquid level 16 and past their associated magnetically actuatable switches 40. As this occurs, the fluid-present lights 34 (which are off) will remain off and the fluid-not-present lights 38 (which are on) will remain on. Once the gauge 20 is drained, the drain 53 is then closed and the fluid 24 in the tank 12 begins to fill the gauge 20. As the gauge 20 fills, the float 26 rises. The rising of the float 26 turns on the fluid-present lights 34 and turns off the fluid-not-present lights 38 as the float passes the associated magnetically actuatable switches 40. The float 26 rises until it reaches a vertical position that is substantially equal vertically to the liquid level 16. Once the float 26 reaches this point, the lights 34, 38 below the liquid level 16 are in their correct state: the fluid-present lights 34 located below the liquid level are turned on and the fluid-not-present lights 38 located below the liquid level are turned off.

This process of setting the lights located below the liquid level 16 to their correct state may, alternatively, be accomplished using a pulling device as shown schematically at 56. The pulling device 56 is used to pull the float 26 downward until it reaches the bottom of the gauge 20. As the float 26 thereafter rises to its previous position, the fluid-present lights 34 located below the liquid level 16 are turned on and the fluid-not-present lights 38 located below the liquid level 16 are off. The pulling device 56 may be pulled either manually or automatically, for example, using a motor.

As another alternative, a pushing device as shown schematically at 58 may be used to push the float 26 to the bottom of the gauge. The float 26 when it thereafter rises causes the lights 34, 38 to be set to their correct state. The pushing device 58 may be pushed manually or automatically.

Yet another method of setting the lights to their correct state is to use a magnet, such as the magnet 54 shown in FIG. 9. The auxiliary magnet 54, either manually or automatically, is passed by the magnetically actuatable switches 40 that are located below the float 26. The auxiliary magnet 54 switches the magnetically actuatable switches 40 in the same way that the magnetic device 27 switches the magnetically actuatable switches 40 in the previous methods.

In yet another method of setting the lights 34, 38 to their correct state, a microprocessor (FIG. 9) can be used. In this method, signals indicative of the states of the lights 34, 38 and the position of the float 26 are sent to a calibrated microprocessor. A signal can be sent back to the indicator 10, specifically to each light 34, 38 or magnetically actuatable switch 40 that is in an incorrect state, to change the state and set that particular light to its correct state. In other words, the microprocessor can determine which lights are showing the correct state and which need to be changed based on the position of the float 26. The microprocessor may then provide signals to change the state of specific lights 34, 38.

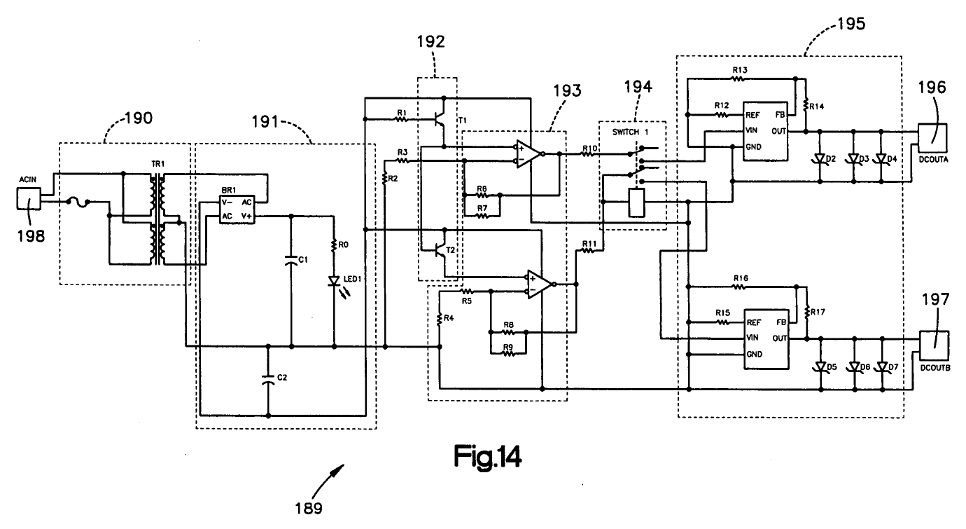

As discussed above, the indicators shown in FIGS. 12 and 13 are driven from a negative DC voltage supply 52. A power supply 189 which provides the necessary negative DC voltage is illustrated in FIG. 14. The power supply 189 operates by first stepping down an AC input voltage 198 using a voltage step-down circuit 190. In the illustrated embodiment, a center tapped transformer is used, although other types of circuitry may be used. The stepped-down AC voltage is then converted to DC voltage using a voltage conversion circuit 191. In the illustrated embodiment, a four diode rectifier is used to convert the AC voltage to DC voltage. The positive DC voltage is used within the voltage conversion circuit 191 to light an LED to indicate to a user that the power supply 189 has power.

The negative DC voltage is then input into a voltage splitting circuit 192 to split and balance the voltage to ultimately provide two outputs (although more than two outputs are possible). The voltage splitting circuit 192 in the illustrated embodiment uses DC coupling to split and balance the negative DC voltage into two negative DC voltages.

The two negative DC voltages are then input into an amplification circuit 193 where each of the two negative DC voltages is increased to compensate for the losses that have occurred in the preceding circuit. Also, the amplification circuit 193 aids in raising the voltage to its ultimately desired level.

The amplified voltages are then passed through an optional electromechanical switch 194. The switch 194 is closed when the power supply is on and may be used to produce a current spike which is necessary to drive some types of magnetically actuatable switches 40 to a desired state. Some types of magnetically actuatable switches 40 do not require a current spike to start at a default state, in which case, the electromechanical switch 194 may not be necessary.

After passing through the electromechanical switch 194, the two negative DC voltages are input to a voltage regulation circuit 195. The voltage regulation circuit 195 regulates the voltage to provide a substantially constant voltage to the outputs 196, 197. In the illustrated embodiment, the outputs are supplied about −18 volts DC and about 0.35 amps. The desired output voltages and amperage may be adjusted as desired. To help regulate the output, latching circuitry may be used to ensure that the output voltage remains at the desired level. In the illustrated embodiment, three zener diodes ensure that the voltage latches at approximately −18 volts DC. The latching circuitry also helps to make the power supply inherently safe.

Some indicators do not require a negative input voltage. When a positive input voltage is required, the power supply 189a illustrated in FIG. 15 may be used. The power supply 189a illustrated in FIG. 15 is an adjustment of the power supply illustrated in FIG. 14. Specifically, in the positive configuration, the voltage conversion circuit 191a outputs the positive DC voltage instead of the negative DC voltage to the voltage splitting circuit 192a. By making this adjustment, the outputs will have about +18 volts DC and 0.35 amps instead of −18 volts DC.

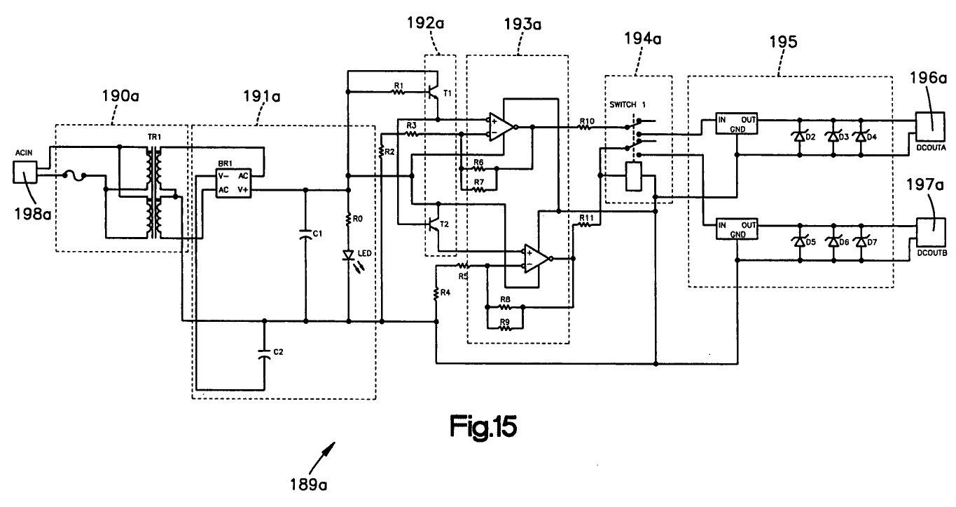

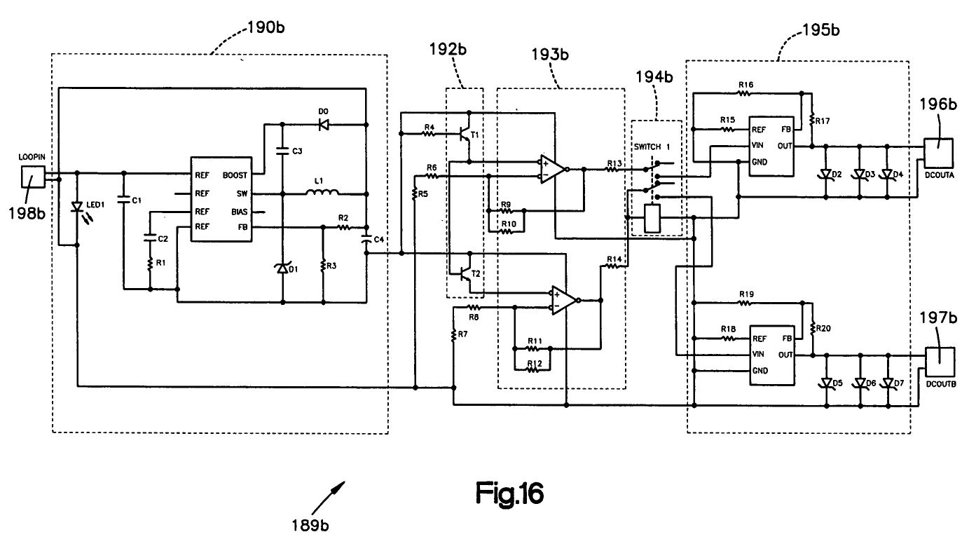

Finally, the power supply may not always have available an AC input source. In those cases, the power supply can be adapted to use a DC input source, as illustrated in FIG. 16. As shown in FIG. 16, a DC input source 198b is used by the power supply 189b. The voltage step-down circuit is adapted to step down the DC input voltage to the desired DC voltage and polarity. The remaining parts of the power supply 189b do not vary from those of the power supply 189 illustrated in FIG. 14 and therefore operate in a similar manner. Since the input source is a DC source, a voltage conversion circuit 191 is not needed. As can be seen from the above discussion, the power supply for the indicator 10 can be adjusted as needed based on the input source and the desired output.

From the above description of the invention, those skilled in the art will perceive improvements, changes, and modifications in the invention. For example, each row of lights could include more than two lights, and a remote readout need not be used. Such improvements, changes, and modifications within the skill of the art are intended to be included within the scope of the appended claims.

1. A method of indicating level of fluid in a tank using an indicator having a float that rises and falls with the level of fluid in said tank, comprising the steps of:
turning on a fluid-present light corresponding to a vertical position of said float; and
turning on a fluid-not-present light at all other positions.

2. The method as set forth in claim 1, wherein said fluid-present lights are different in color than said fluid-not-present lights.

3. The method as set forth in claim 1, wherein said float provides two opposing magnetic fields that move vertically as said float rises and falls.

4. The method as set forth in claim 3, wherein said step of turning on the fluid-present light further comprises the step of:
actuating a magnetically actuatable switch with one of said magnetic fields of said float.

5. The method as set forth in claim 4, wherein said magnetically actuatable switch is a latching Hall effect transistor.

6. The method as set forth in claim 4, wherein said magnetically actuatable switch is selected from the group consisting of an A3187EUA-type, UGN3175XUA-type and UGN3177XUA-type Hall effect transistor.

7. The method as set forth in claim 4, further comprising the steps of:
outputting a level-indication signal based on the actuating of said magnetically actuatable switch to a microprocessor; and
controlling said fluid-present light and said fluid-not-present light using a control signal from said microprocessor which is based on said level-indication signal.

8. The method as set forth in claim 3, wherein said step of turning on the fluid-not-present light includes the step of:
driving a magnetically actuatable switch to a default state using a current spike.

9. The method as set forth in claim 8, wherein said magnetically actuatable switch is a latching Hall effect transistor and wherein said default state is off.

10. The method as set forth in claim 1, wherein said indicator is powered using a negative input voltage.

11. The method as set forth in claim 1 further comprising the step of:
providing said indicator with a negative DC voltage upon power up.

12. The method as set forth in claim 11, wherein said providing step includes providing about −18 volts DC and about 0.35 amps to said indicator.

13. The method as set forth in claim 1, further comprising the subsequent steps of:
turning off said fluid-not-present light located below the level of fluid in said tank; and
turning on said fluid-present light located below the level of fluid in said tank.

14. The method as set forth in claim 13, wherein said step of turning off said fluid-not-present light located below the level of fluid in said tank and said step of turning on said fluid-present light located below the level of fluid in said tank include the steps of:
draining fluid from a gauge which houses said float such that said float moves past said fluid-not-present light located below the level of fluid in said tank and said fluid-present light located below the level of fluid in said tank; and
filling said gauge with said fluid from said tank.

15. The method as set forth in claim 14, wherein said draining step is manually performed.

16. The method as set forth in claim 14, wherein said draining step is automatically performed.

17. The method as set forth in claim 13, wherein said steps of turning off said fluid-not-present light located below the level of fluid in said tank and turning on said fluid-present light located below the level of fluid in said tank are performed using signals from a microprocessor.

18. The method as set forth in claim 13, wherein said steps of turning off said fluid-not-present light located below the level of fluid in said tank and turning on said fluid-present light located below the level of fluid in said tank include the step of:
moving a magnet past said fluid-not-present light located below the level of fluid in said tank and said fluid-present light located below the level of fluid in said tank.

19. The method as set forth in claim 18, wherein said moving step is manually performed.

20. The method as set forth in claims 18, wherein said moving step is automatically performed.

21. The method as set forth in claim 13, wherein said steps of turning off said fluid-not-present light located below the level of fluid in said tank and turning on said fluid-present light located below the level of fluid in said tank include the step of:
pulling said float downwardly past said fluid-not-present light located below the level of fluid in said tank and said fluid-present light located below the level of fluid in said tank.

22. The method as set forth in claims 21, wherein said pulling step is manually performed.

23. The method as set forth in claim 21, wherein said pulling step is automatically performed.

24. The method as set forth in claim 13, wherein said steps of turning off said fluid-not-present light located below the level of fluid in said tank and turning on said fluid-present light located below the level of fluid in said tank include the step of:
pushing said float downwardly past said fluid-not-present light located below the level of fluid in said tank and said fluid-present light located below the level of fluid in said tank.

25. The method as set forth in claims 24, wherein said pushing step is manually performed.

26. The method as set forth in claim 24, wherein said pushing step is automatically performed.

27. The method as set forth in claim 1, wherein said fluid-not-present light and said fluid-present light are arranged to form a circular shape.

28. The method as set forth in claim 1, wherein said fluid-not-present lights and said fluid-present lights are arranged to form an arcuate shape.

29. The method as set forth in claim 1, wherein said fluid-not-present lights and said fluid-present lights are arranged to form a linear shape.

30. A liquid level indicator for indicating level of liquid in a tank, comprising:
a fluid-present light located at a discrete vertical position;
a fluid-not present light positioned and associated with said fluid-present light; and
a magnetically actuatable switch in electrical connection with said fluid-present light and said fluid-not-present light,
wherein said magnetically actuatable switch latchedly turns on said fluid present-light and turns off said fluid-not-present light as a magnetic device passes said magnetically actuatable switch in a first direction, and
wherein said magnetically actuatable switch latchedly turns off said fluid-present light and turns on said fluid-not-present light as said magnetic device passes said magnetically actuatable switch in a second direction.

31. The liquid level indicator as set forth in claim 30, wherein said magnetically actuatable switch is a latching Hall effect transistor,

32. The liquid level indicator as set forth in claim 31, wherein said magnetically actuatable switch is a three-pin Hall effect transistor.

33. The liquid level indicator as set forth in claim 32, wherein a control transistor is disposed in series with said fluid-not-present light and wherein a gate of said control transistor is electrically tied to an output of said three-pin Hall effect transistor.

34. The liquid level indicator as set forth in claim 32, wherein a ground pin of said three-pin Hall effect transistor is electrically tied to a VCC pin of a different serially-connected Hall effect transistor.

35. The liquid level indicator as set forth in claim 32, wherein said fluid-present light is electrically connected between an output pin of said three-pin Hall effect transistor and a ground pin of a different serially-connected Hall effect transistor.

36. The liquid level indicator of claim 32, wherein said fluid-present light and said fluid-not-present light are arranged as a pair at said discrete vertical position.

37. The liquid level indicator of claim 36, wherein in each pair, one and only one of said lights is on.

38. The liquid level indicator as set forth in claim 31, wherein said magnetically actuatable switch is a four-pin Hall effect transistor.

39. The liquid level indicator as set forth in claim 30, wherein said liquid level indicator is operable to be powered by negative DC voltage.

40. The liquid level indicator as set forth in claim 30, wherein a ground pin of said magnetically actuatable switch is electrically connected to a negative DC voltage.

41. The liquid level indicator as set forth in claim 30, wherein a VCC pin of said magnetically actuatable switch is electrically connected to ground.

42. The liquid level indicator of claim 30, wherein the liquid level indicator includes a plurality of fluid-present lights and corresponding fluid-not-present lights at different discrete vertical positions.

43. The liquid level indicator of claim 30, wherein said fluid-present light and said fluid-not-present light are arranged as a pair at said discrete vertical position.

44. The liquid level indicator of claim 43, wherein in each pair, one and only one of said lights is on.

45. The liquid level indicator of claim 30, wherein said fluid-present light, said fluid-not-present light and said magnetically actuatable switch form a group, and wherein said liquid level indicator includes a plurality of groups.

46. The liquid level indicator of claim 45, wherein said plurality of groups are electrically connected in series.

47. The liquid level indicator of claim 45, wherein a predetermined number of groups are electrically connected in series to form a branch, and wherein said liquid level indicator includes a plurality of branches electrically connected in parallel.

48. The liquid level indicator of claim 47, wherein each one of said branches is electrically connected between ground and a negative input voltage.

49. The liquid level indicator of claim 30, further comprising:
a floating device containing said magnetic device, wherein said floating device is operable to float at a vertical level substantially equal to a vertical level of the liquid in said tank as said liquid level rises and falls.

50. The liquid level indicator of claim 30, wherein said magnetic device provides:
a first magnetic field flowing in a first direction; and
a second magnetic field, below said first magnetic field and flowing in a second direction opposite to said first direction.

51. The liquid level indicator of claim 50, wherein said first magnetic field is provided by a first magnet and said second magnetic field is provided by a second magnet.

52. The liquid level indicator of claim 50, wherein said first magnetic field turns said magnetically actuatable switch off which turns off said fluid-present light and turns on said fluid-not-present light; and
wherein said second magnetic field turns said magnetically actuatable switch on which turns on said fluid-present light and turns off said fluid-not-present light.

53. The liquid level indicator of claim 30, wherein said liquid level indicator is inherently safe.

54. The liquid level indicator as set forth in claim 30, wherein said fluid-not-present light and said fluid-present light are remotely located from said magnetically actuatable switch.

55. A power supply for a liquid level indicator, comprising:
a power input having an input voltage;
a voltage step-down circuit electrically connected to said power input for stepping down said input voltage to a stepped-down voltage;
an amplification circuit to adjust the stepped-down voltage to a predetermined voltage;
a voltage regulation circuit electrically connected to said amplification circuit for producing a regulated output voltage and output current; and
a voltage splitting circuit disposed electrically between said voltage step-down circuit and said amplification circuit,
wherein said voltage splitting circuit is operable to produce multiple outputs having substantially equal voltage,
wherein said amplification circuit produces multiple outputs having substantially equal voltage, and
wherein said voltage regulation circuit produces multiple outputs having substantially equal voltage and current.

56. The power supply as set forth in claim 55, further comprising:
a voltage conversion circuit operable to convert an AC voltage to DC voltage, wherein said input voltage is an AC voltage.

57. The power supply as set forth in claim 56, wherein said regulated output voltage is a negative DC voltage.

58. The power supply as set forth in claim 57, wherein said regulated output voltage is about negative 18 volts DC and said regulated output current is about 0.35 amps.

59. The power supply as set forth in claim 56, wherein said regulated output voltage is a positive DC voltage.

60. The power supply as set forth in claim 56, wherein said voltage conversion circuit is a four diode rectifier.

61. The power supply as set forth in claim 55, wherein said input voltage is a DC voltage and wherein said regulated output voltage is a negative DC voltage.

62. The power supply as set forth in claim 61, wherein said regulated output voltage is about negative 18 volts DC and said regulated output current is about 0.35 amps.

63. The power supply as set forth in claim 61, wherein said power supply is intrinsically safe.

64. The power supply as set forth in claim 55, further comprising:
an electromechanical switch disposed electrically between said amplification circuit and said voltage regulation circuit operable to provide a current spike.

65. A method of setting fluid-present lights and fluid-not-present lights located below the level of fluid in a tank after power up, comprising the steps of:
turning off each of said fluid-not-present lights, that is turned on as a result of power up; and
turning on each of said fluid-present lights, that is not turned on as a result of power up.

66. The method as set forth in claim 65, wherein said steps of turning off each of said fluid-not-present lights and turning on each of said fluid-present lights include the step of:
draining fluid from a gauge which houses a float having a magnetic device such that said float moves past each of said fluid-not-present lights located below the level of fluid in said tank and said fluid-present lights located below the level of fluid in said tank.

67. The method as set forth in claim 65, wherein said steps of turning off each of said fluid-not-present lights and turning on each of said fluid-present lights are performed using signals from a microprocessor.

68. The method as set forth in claim 65, wherein said steps of turning off each of said fluid-not-present lights and turning on each of said fluid-present lights include the step of:
moving a magnetic device past each of said fluid-not-present lights located below the level of fluid in said tank and said fluid-present lights located below the level of fluid in said tank.

69. The method as set forth in claim 65, wherein said steps of turning off each of said fluid-not-present lights and turning on each of said fluid-present lights include the step of:
pulling a float having a magnetic device downwardly past each of said fluid-not-present lights located below the level of fluid in said tank and said fluid-present lights located below the level of fluid in said tank.

70. The method as set forth in claim 65, wherein said steps of turning off each of said fluid-not-present lights and turning on each of said fluid-present lights include the step of:
pushing a float having a magnetic device downwardly past each of said fluid-not-present lights located below the level of fluid in said tank and said fluid-present lights located below the level of fluid in said tank.
